(19) United States
(12) Patent Application Publication
(10) Pub. No.: US 2012/0021292 A1
(43) Pub. Date: Jan. 26, 2012

(54) Anode active material for lithium secondary battery and method for preparing the same

(75) Inventors: Hidekazu Awano, Tokyo (JP); Kazuya Taga, Tokyo (JP); Katsuyuki Negishi, Tokyo (JP)

(73) Assignee: NIPPON CHEMICAL INDUSTRIAL CO. LTD., Tokyo (JP)

(21) Appl. No.: 13/137,039

(22) Filed: Jul. 18, 2011

(30) Foreign Application Priority Data
Jul. 20, 2010 (JP) 2010-162898

(51) Int. Cl. H01M 4/485

(52) U.S. Cl. 429/231.1; 252/182.1

(57) ABSTRACT

An anode active material for lithium secondary batteries including lithium titanate represented by the following general formula (1): LiₓTi_{y}O₁₂ (1) (wherein x and y satisfy 3.0≦x≦5.0, 4.0≦y≦6.0 and 0.70≦x/y≦0.90), and a magnesium compound.

### BACKGROUND

1. Technical Field

The present invention relates to an anode active material for lithium secondary batteries and a method for preparing the same.

2. Description of the Related Art

Lithium secondary batteries which use lithium titanate as an active material have a long lifespan due to small volume expansion during charging and discharging. For this reason, lithium titanate is a material which attracts much attention in the field of hybrid electric vehicles (HEVs) or stationary large batteries. In addition, lithium titanate may be used as an anode active material as well as a cathode active material and use thereof in such a field is thus expected.

However, lithium secondary batteries which use lithium titanate as an anode active material have disadvantages of low diffusion rate of lithium ions, unsuitability for rapid charging and discharging and poor stability at high temperatures.

Accordingly, a large number of attempts to improve battery characteristics have been made. For example, Japanese Unexamined Patent Application Publication No. 10-251020 (claims) discloses metal-substituted lithium titanate wherein a part of lithium is substituted by di- or more valent metals and the substitution metal is at least one selected from the group consisting of cobalt, nickel, manganese, vanadium, iron, boron, aluminum, silicon, zirconium, strontium, magnesium and tin, a method for preparing the same and a lithium secondary battery including the same.

In addition, Japanese Unexamined Patent Application Publication 2000-302547 (claims) discloses a method for preparing lithium titanate containing a small amount of impurities using highly pure titanium oxide.

In addition, Japanese Unexamined Patent Application Publication 2004-235144 (claims) discloses use of lithium titanate which contains sulfur, and an alkali metal and/or an alkaline earth metal.

In addition, Japanese Unexamined Patent Application Publication 2006-221881 (claims) or Japanese Unexamined Patent Application Publication 2006-40738 (claims) discloses an active material in which a carbon material is incorporated in lithium titanate.

### SUMMARY

However, although the anode active material of the prior art is applied to lithium secondary batteries, satisfactory properties, more specifically, satisfactory high-temperature storage properties and rapid charging and discharging properties cannot be obtained. Accordingly, there is an expectation for developing anode active materials for lithium secondary batteries which can impart superior properties to lithium secondary batteries.

Accordingly, it is desirable to provide an anode active material for lithium secondary batteries capable of imparting superior high-temperature storage properties and rapid charging and discharging properties to lithium secondary batteries.

As a result of intense research, taking the circumstances into consideration, the inventors of the present invention discovered that superior high-temperature storage properties and excellent rapid charging and discharging properties can be imparted to lithium secondary batteries by incorporating lithium titanate and a magnesium compound in an anode active material. The present invention has been completed, based on this discovery.

That is, a first aspect of the present invention is to provide an anode active material for lithium secondary batteries including lithium titanate represented by the following general formula (1); and a magnesium compound

LiₓTi_{y}O₁₂ (1)

(wherein x and y satisfy 3.0≦x≦5.0, 4.0≦y≦6.0, 0.70≦x/y≦0.90).

In addition, a second aspect of the present invention is to provide a method for preparing an anode active material for lithium secondary batteries, including incorporating a magnesium compound in lithium titanate represented by the following general formula (1):

LiₓTi_{y}O₁₂ (1)

(wherein x and y satisfy 3.0≦x≦5.0, 4.0≦y≦6.0 and 0.70≦x/y≦0.90).

In addition, a third aspect of the present invention is to provide a method for preparing an anode active material for lithium secondary batteries, including mixing a lithium titanate material with a magnesium compound material in an aqueous solvent to obtain an aqueous slurry (A) (wet mixing process (A)) and heating the aqueous slurry (A) to 50 to 500° C. to obtain an anode active material for lithium secondary batteries (heating process (A)), wherein the lithium titanate material is lithium titanate represented by the following general formula (1):

LiₓTi_{y}O₁₂ (1)

(wherein x and y satisfy 3.0≦x≦5.0, 4.0≦y≦6.0 and 0.70≦x/y≦0.90).

In addition, a fourth aspect of the present invention is to provide an anode active material used for lithium secondary batteries according to the first aspect of the present invention.

The present invention provides an anode active material for lithium secondary batteries which imparts superior high-temperature storage properties and excellent rapid charging and discharging properties to lithium secondary batteries.

### BRIEF DESCRIPTION OF THE DRAWINGS

FIG. 1 is an X-ray diffraction image of a lithium titanate material used in Examples.

FIG. 2 is an X-ray diffraction image of an anode active material obtained in Example 1.

FIG. 3 is an SEM image of an anode active material obtained in Example 1.

FIG. 4 is an X-ray diffraction image of an anode active material obtained in Example 2.

FIG. 5 is an SEM image of an anode active material obtained in Example 2.

FIG. 6 is an X-ray diffraction image of an anode active material obtained in Comparative Example 1.

FIG. 7 is an X-ray diffraction image of an anode active material obtained in Comparative Example 2.

### DETAILED DESCRIPTION

Hereinafter, the present invention will be described in detail with reference to the preferred embodiments. The anode active material for lithium secondary batteries of the present invention contains lithium titanate represented by the following general formula (1):

LiₓTi_{y}O₁₂ (1)

(wherein x and y satisfy 3.0≦x≦5.0, 4.0≦y≦6.0 and 0.70≦x/y≦0.90), and a magnesium compound.

The anode active material for lithium secondary batteries of the present invention consists of lithium titanate represented by the general formula (1) and a magnesium compound. In other words, the anode active material for lithium secondary batteries of the present invention is lithium titanate represented by general formula (1) containing a magnesium compound.

Embodiments of anode active material for lithium secondary battery of the present invention are as follows.

(i) An embodiment, as a mixture of primary particles of lithium titanate represented by general formula (1) and a magnesium compound

(ii) An embodiment wherein lithium titanate represented by general formula (1) is composed of primary particles and the surfaces of primary particles are covered with a magnesium compound (an embodiment as primary particles of lithium titanate represented by general formula (1) wherein the surfaces of primary particles are covered with a magnesium compound wherein the primary particles are not aggregated)

(iii) An embodiment, as a mixture of aggregations (secondary particles) of a plurality of primary particles of lithium titanate represented by general formula (1) and a magnesium compound

(iv) An embodiment wherein a plurality of primary particles of lithium titanate represented by general formula (1) is aggregated to form aggregations (secondary particles), wherein the surfaces of secondary particles are covered with a magnesium compound (an embodiment wherein the surfaces of secondary particles composed of aggregations of a plurality of primary particles of lithium titanate represented by general formula (1) are covered with a magnesium compound)

(v) An embodiment wherein a plurality of primary particles of lithium titanate represented by general formula (1) is aggregated together with a magnesium compound to form aggregations (secondary particles)

(vi) An embodiment wherein a plurality of primary particles of lithium titanate represented by general formula (1), in which the surfaces of primary particles are covered with a magnesium compound, is aggregated to form aggregations (secondary particles) (an embodiment wherein a plurality of primary particles of lithium titanate represented by general formula (1), whose surfaces are covered with a magnesium compound, is aggregated to form aggregations (secondary particles))

In the embodiment (i), provided is a mixture of primary particles of lithium titanate represented by general formula (1) without being aggregated and a magnesium compound. In addition, in the embodiment (ii), the magnesium compound is present such that it entirely or partially covers the surface of primary particles of lithium titanate represented by general formula (1), and primary particles of lithium titanate represented by general formula (1) whose surfaces are covered with the magnesium compound are not aggregated. In addition, in the embodiment (iv), the magnesium compound is present such that it entirely or partially covers the surfaces of secondary particles of lithium titanate represented by general formula (1). In addition, in the embodiment (v), the magnesium compound is present together with primary particles of lithium titanate in the secondary particles of lithium titanate represented by general formula (1). In addition, in the embodiment (vi), the magnesium compound is present such that it entirely or partially covers the surfaces of primary particles of lithium titanate represented by general formula (1) forming secondary particles.

In addition, the anode active material for lithium secondary batteries of the present invention may be provided as a combination of the embodiments (i) to (vi). In addition, the anode active material may be further provided as a combination of ground secondary particles of the embodiments (iii) to (vi).

The embodiment (v) or (vi) among the embodiments (i) to (vi), of the anode active material for lithium secondary batteries of the present invention is preferred in that battery performances of lithium secondary batteries, such as high-temperature storage properties and rapid charging and discharging properties are further improved, when the anode active material of lithium secondary batteries is used.

The lithium titanate represented by general formula (1) has a spinel structure. In addition, the term “spinel structure” refers to an octahedral crystalline structure which belongs to cubic crystal systems.

In the general formula (1), x satisfies 3.0≦x≦5.0, preferably 3.5≦x≦4.5, and y satisfies 4.0≦y≦6.0, preferably 4.5≦y≦5.5. A molar ratio of lithium atoms to titanium atoms (Li/Ti), that is, x/y satisfies 0.70≦x/y≦0.90, preferably 0.75≦x/y≦0.85. When the values of x, y and x/y are within the range defined above, discharge capacity increases.

The magnesium compound related to the anode active material for lithium secondary batteries of the present invention is not particularly limited and examples thereof include magnesium oxide; or inorganic magnesium salts such as magnesium hydroxide, magnesium phosphate, magnesium sulfate, magnesium nitrate, magnesium chloride, magnesium carbonate, magnesium bromide, magnesium hydrogen phosphate and magnesium perchlorate. These magnesium compounds may be used singly or in a combination of two or more types. Of these magnesium compounds, magnesium oxide, magnesium phosphate and magnesium sulfate are preferred in that high-temperature storage properties of lithium secondary batteries are improved.

The primary particles of lithium titanate represented by general formula (1) have a mean particle diameter of 2 μm or less, preferably 0.01 to 1.00 μm. When the mean particle diameter of the primary particles of lithium titanate represented by general formula (1) is within the range defined above, rapid charging and discharging properties of lithium secondary batteries are improved. In addition, in the embodiments (i) and (ii), the term “mean particle diameter” refers to a mean particle diameter of primary particles which are present without being aggregated. In addition, in the embodiments (iii), (iv), (v) and (vi), the term “mean particle diameter” refers to a mean particle diameter of primary particles of the aggregated particles (secondary particles). In addition, the mean particle diameter primary particles of lithium titanate represented by general formula (1) may be measured by scanning electron microscopy (SEM). The measurement of mean particle diameter of primary particles by SEM is carried out by randomizing 100 primary particles, analyzing an image by SEM and calculating the average of diameters of primary particles observed by SEM.

In the embodiments (iii), (iv), (v) and (vi), the mean particle diameter of secondary particles is 0.10 to 20.00 μm, preferably 0.10 to 15.00 μm. When the mean particle diameter of secondary particles is within the range defined above, rapid charging and discharging properties of lithium secondary batteries are improved. In addition, the mean particle diameter of secondary particles is measured with a particle size distribution meter (under the trade name of MICROTRAC, Model No. MT3000II, manufactured by NIKKISO CO., LTD.) using a laser method.

In addition to the physical properties, in the embodiments (iii), (iv), (v) and (vi), a BET specific surface area is preferably 1.0 to 50 m²/g, more preferably, 1.0 to 20 m²/g. When the BET specific surface area is within the range defined above, rapid charging and discharging performances of lithium secondary batteries can be further improved.

In the anode active material for lithium secondary batteries of the present invention, a weight ratio (%) of magnesium atoms to lithium titanate represented by general formula (1) ((Mg in terms of atoms/lithium titanate)×100) is 0.1 to 5.0% by weight, preferably 0.5 to 3.0% by weight. When the weight ratio (%) of magnesium atoms to lithium titanate represented by general formula (1) is within the range defined above, high-temperature storage properties of lithium secondary batteries are improved. In addition, the weight ratio (%) of magnesium atoms to lithium titanate represented by general formula (1) refers to a weight ratio of the weight of lithium titanate represented by general formula (1) present in the anode active material for lithium secondary batteries of the present invention, and the weight of Mg atoms (weight in terms of atoms) constituting the magnesium compound present in the anode active material for lithium secondary batteries of the present invention.

When the crystalline structure of lithium titanate is analyzed by X-ray diffractometry (XRD analysis), diffraction peaks derived from lithium titanate in the X-ray diffraction chart of magnesium-doped lithium titanate are shifted as compared to lithium titanate in which magnesium is not doped. In addition, when the anode active material for lithium secondary batteries of the present invention is analyzed by XRD, diffraction peaks derived from lithium titanate in the X-ray diffraction chart of magnesium-doped lithium titanate are not shifted, as compared to lithium titanate in which magnesium is not doped. The magnesium-doped lithium titanate has an a-axis lattice constant of 8.362 to 8.365 angstroms, and the lithium titanate of the present invention has an a-axis lattice constant of 8.359 to 8.361 angstroms, preferably 8.360 to 8.361 angstroms. For this reason, the lithium titanate represented by general formula (1) present in the anode active material for lithium secondary batteries of the present invention is barely doped with magnesium. That is, 95% or more of the lithium titanate represented by general formula (1) of the anode active material for lithium secondary batteries of the present invention is lithium titanate in which magnesium is not doped.

When the anode active material for lithium secondary batteries of the present invention is used as an anode active material, high-temperature storage properties and rapid charging and discharging properties of lithium secondary batteries can be improved. In addition, the anode active material for lithium secondary batteries of the present invention exhibits superior high-temperature storage properties, as compared to magnesium-doped lithium titanate.

The anode active material for lithium secondary batteries of the present invention is suitably prepared by a method for preparing the anode active material for lithium secondary batteries of the present invention described below.

The preparation method of the anode active material for lithium secondary batteries of the present invention is characterized in that a magnesium compound is incorporated in lithium titanate represented by general formula (1).

The lithium titanate represented by general formula (1) and the magnesium compound related to the preparation method of the anode active material for lithium secondary batteries of the present invention are the same as the lithium titanate represented by general formula (1) and the magnesium compound related to the anode active material for lithium secondary batteries of the present invention.

The preparation method of the anode active material for lithium secondary batteries of the present invention may be for example in accordance with the following embodiments.

The first embodiment of the preparation method of the anode active material for lithium secondary battery according to the present invention (hereinafter, referred to a preparation method (1) of the anode active material for lithium secondary batteries of the present invention) includes mixing a lithium titanate material with a magnesium compound material in an aqueous solvent to obtain an aqueous slurry (A) (wet mixing process (A)) and heating the aqueous slurry (A) to 50 to 500° C. to obtain an anode active material for lithium secondary batteries (heating process (A)), wherein the lithium titanate material is lithium titanate represented by the general formula (1).

In the wet mixing process (A) related to the preparation method (1) of the anode active material for lithium secondary batteries of the present invention, the lithium titanate material is mixed with the magnesium compound material by a wet method and an aqueous slurry (A) is obtained by mixing the lithium titanate material with the magnesium compound material in an aqueous solvent.

The lithium titanate material related to the wet mixing process (A) is lithium titanate represented by general formula (1) and the lithium titanate represented by general formula (1) may be composed of primary particles, or secondary particles, as the form of aggregations of primary particles of lithium titanate represented by general formula (1), or a mixture of the primary particles and secondary particles. In addition, the primary particles of lithium titanate represented by general formula (1) may be obtained by grinding secondary particles.

The mean particle diameter of primary particles of lithium titanate material related to the wet mixing process (A) is 2.0 μm or less, preferably 0.01 to 1.00 μm, particularly preferably 0.01 to 0.50 μm. In addition, the mean particle diameter of primary particles of lithium titanate material is measured by scanning electron microscopy (SEM). The measurement of mean particle diameter of primary particles by SEM is carried out by randomizing 100 primary particles, analyzing an image by SEM and calculating the average of diameters of primary particles observed by SEM. In addition, when the lithium titanate material is composed of secondary particles, as the form of aggregations of primary particles of lithium titanate, the mean particle diameter of the primary particles of lithium titanate material refers to a mean particle diameter of primary particles constituting the secondary particles.

When the lithium titanate material related to the wet mixing process (A) is composed of secondary particles, the mean particle diameter of secondary particles, as the form of aggregations of primary particles of lithium titanate, is 0.10 to 20.00 μm, preferably 0.10 to 15.00 μm. In addition, the mean particle diameter of secondary particles of the lithium titanate material is measured with a particle size distribution meter using a laser method.

The preparation method of lithium titanate material related to the wet mixing process (A) is not particularly limited. The lithium titanate material prepared by the following preparation method (1) of lithium titanate material is preferred in that it exhibits excellent production efficiency and superior high-temperature storage properties.

Examples of the magnesium compound material related to the wet mixing process (A) include magnesium oxide; inorganic magnesium compounds such as magnesium hydroxide, magnesium phosphate, magnesium sulfate, magnesium nitrate, magnesium chloride, magnesium carbonate, magnesium bromide, magnesium hydrogen phosphate, magnesium perchlorate; and organic magnesium compounds such as magnesium acetate, magnesium oxalate, magnesium lactate and magnesium stearate. These magnesium compound materials may contain or do not contain crystal water.

Of the magnesium compound material related to the wet mixing process (A), the organic magnesium compound is preferably heated to 50 to 500° C. during the heating process (A), and is thus decomposed and converted into magnesium oxide. In addition, the inorganic magnesium compound may be heated to 50 to 500° C. during the heating process (A), and be thus decomposed and converted into magnesium oxide.

Examples of the magnesium compound material related to the wet mixing process (A) include water-soluble magnesium compound materials such as magnesium sulfate and magnesium acetate, and magnesium compound materials sparingly soluble in an aqueous solvent such as magnesium oxide and magnesium phosphate. When a magnesium material sparingly soluble in an aqueous solvent is used, taking consideration into homogeneous mixing, the mean particle diameter of the sparingly soluble magnesium compound material is 10 μm or less, preferably 0.5 to 2 μm, when measured with a particle size distribution meter using a laser method. In addition, as used herein, the term “a magnesium compound material sparingly soluble in an aqueous solvent” refers to a magnesium compound material which has a solubility in water at 10° C., of less than 10 g/water 100 g.

In the wet mixing process (A), a mixed amount of the lithium titanate material and the magnesium compound material corresponds to 0.1 to 5.0% by weight, preferably 0.5 to 3.0% by weight, as a weight ratio (%) of Mg atoms in the magnesium compound material to the lithium titanate material (Mg (in terms of atoms in magnesium compound material/lithium titanate material)×100). When the mixed amounts of the lithium titanate material and the magnesium compound material are within the range defined above, high-temperature storage properties are improved.

In the wet mixing process (A), the amount of aqueous solvent used is determined such that a weight ratio of the lithium titanate material in the aqueous slurry (A) is adjusted to 5 to 60% by weight, preferably 10 to 50% by weight.

In the wet mixing process (A), a method for mixing (wet mixing) the lithium titanate material with the magnesium compound material in an aqueous solvent includes a method for wet-mixing the lithium titanate material with the magnesium compound material while wet-grinding secondary particles of lithium titanate in an aqueous slurry (A-1), and a method for wet-mixing the lithium titanate material with the magnesium compound material, while not grinding or barely grinding secondary particles of lithium titanate in an aqueous slurry (A-2).

The wet mixing method (A-1) may be carried out by wet-mixing the lithium titanate material with the magnesium compound material, while rapidly stirring a granular medium together in an aqueous slurry. For example, the granular medium is rapidly stirred with an aqueous slurry in an apparatus such as a bead mill. When the wet mixing process (A) is performed by the wet mixing method (A-1), although secondary particles in the form of aggregations of primary particles of lithium titanate are used as a lithium titanate material, an aqueous slurry (A) in which lithium titanate represented by general formula (1) is dispersed in the form of primary particles in an aqueous medium can be obtained, since the secondary particles are ground and converted into the primary particles.

Examples of the granular medium for the wet mixing method (A-1) include ceramic beads, resin beads and the like. Examples of the shape of granular medium include spherical, pyramidal, circular and amorphous shapes. The granular medium has a particle size of 0.05 to 10 mm, preferably 0.1 to 3 mm.

In the wet mixing method (A-1), the condition in which a granular medium is rapidly stirred, for example, in a case where a bead mill apparatus is used, is a condition in which the granular medium is moved in the apparatus at a peripheral velocity of 0.1 to 25 m/sec, preferably 1 to 20 m/sec. In addition, in the wet mixing method (A-1), conditions allowing secondary particles of lithium titanate to be ground into primary particles and the ground primary particles to be more finely ground by applying a strong shear force to secondary particles of lithium titanate in the aqueous slurry (A) are suitably selected. For example, factors such as movement speed of granular media, time for mixing the lithium titanate material with the magnesium material, mixing temperature, bead material and bead mill diameter are suitably selected. In the wet mixing method (A-1), the solid in the slurry is particularly preferably wet-ground, until the mean particle diameter of solid in the slurry obtained by a laser light scattering method reaches 2.0 μm or less, preferably 0.1 to 1.0 μm from the viewpoint that rapid charging and discharging is improved.

The wet mixing method (A-2) is, for example, carried out by stirring an aqueous slurry (A) using a stirring blade in a stirring vessel.

In the wet mixing process (A), in a case where a water-soluble magnesium compound is used as the magnesium compound material, the magnesium compound material is dissolved in the aqueous solvent of the obtained aqueous slurry (A). In addition, in the wet mixing process (A), in a case where a magnesium compound sparingly soluble in an aqueous solvent is used as the magnesium compound material, the magnesium compound material is dispersed in the aqueous solvent of the obtained aqueous slurry (A).

In the heating process (A) related to the preparation method (1) of the anode active material for lithium secondary batteries of the present invention, the aqueous slurry (A) is heated to 50 to 500° C. to obtain an anode active material for lithium secondary batteries.

In the heating process (A), the aqueous slurry (A) is, for example, heated by spraying the aqueous slurry (A) in a spray dryer, heating the aqueous slurry (A) in a heating vessel in a furnace, or vacuum-dying the aqueous slurry (A) using a medium fluidizing dryer. The heating process (A) is preferably carried out by spraying the aqueous slurry (A) in a spray dryer, from the viewpoint that the embodiment (v) or (vi) is obtained in one step.

In the heating process (A), the temperature at which the aqueous slurry (A) is heated is 50 to 500° C., preferably 50 to 400° C. Particularly, in a case where the heating process (A) is carried out using a spray dryer, the heating temperature is 50 to 350° C., preferably 50 to 250° C. In addition, in a case where the heating process (A) is carried out by heating the aqueous slurry (A) contained in a heating vessel in a furnace, the heating temperature is 100 to 500° C., preferably 100 to 400° C. When the heating temperature is lower than the range defined above, the aqueous solvent may readily remain in the anode active material for lithium secondary batteries, and when the heating temperature exceeds the range defined above, lithium titanate may be readily doped with magnesium.

In the heating process (A), the time for which the aqueous slurry (A) is heated is suitably selected depending on heating method. For example, in a case where the heating process (A) is carried out using a spray dryer, the heating time is several minutes. In addition, in a case where heating process (A) is carried out by heating the aqueous slurry (A) contained in a heating vessel in a furnace, the heating time is 0.1 to 24 hours, preferably 1 to 12 hours. When the heating time is lower than the range defined above, the aqueous solvent may readily remain in the anode active material for lithium secondary batteries, and when the heating temperature exceeds the range defined above, lithium titanate may be readily doped with magnesium.

In the heating process (A), the aqueous solvent of the aqueous slurry (A) is evaporated by heating. In addition, in a case where a magnesium compound material, for example, an organic magnesium compound, decomposed at a heating temperature during the heating process (A), is used as a magnesium compound material, the magnesium compound material is decomposed and thus converted into magnesium oxide during the heating process (A).

The anode active material for lithium secondary batteries is obtained by performing the preparation method (1) of the anode active material for lithium secondary batteries of the present invention, as mentioned above.

In addition, in accordance with the preparation method (1) of the anode active material for lithium secondary batteries of the present invention, in a case where a water-soluble magnesium compound material is used as the magnesium compound material, primary particles of lithium titanate represented by general formula (1), whose surfaces are covered with the magnesium compound, can easily obtained. Accordingly, use of the water-soluble magnesium compound material as the magnesium compound material is suitable for obtaining an anode active material for lithium secondary batteries of embodiments (ii), (iv) and (vi).

In addition, in the preparation method (1) of the anode active material for lithium secondary batteries of the present invention, in a case where the heating process (A) is carried out using a spray dryer, aggregations (secondary particles) are readily obtained. Accordingly, performing the heating process (A) using a spray dryer is suitable for obtaining the anode active materials for lithium secondary battery of embodiments (v) and (vi).

In addition, in the preparation method (1) of the anode active material for lithium secondary batteries of the present invention, in a case where the wet mixing process (A) is carried out by the wet mixing method (A-1), although secondary particles, as the form of aggregations of primary particles of lithium titanate are used as the lithium titanate material, when the wet mixing process (A) is carried out by the wet mixing method (A-1), the secondary particles are ground and converted into primary particles, thus obtaining an aqueous slurry (A) in which lithium titanate represented by general formula (1) is dispersed in the form of primary particles in an aqueous medium. For this reason, performing the wet mixing process (A) by the wet mixing method (A-1) is suitable for obtaining anode active materials for lithium secondary batteries of embodiments (i), (ii), (v) and (vi).

An example of methods for preparing a lithium titanate material will be illustrated. The preparation method (1) of lithium titanate material includes preparing a mixture of a lithium compound and titanium dioxide which is obtained by a sulfuric acid method and has a specific surface area (based on a BET method) of 1.0 to 50.0 m²/g, to prepare a mixture material for lithium titanate, and baking the mixture of lithium compound and titanium dioxide obtained by the preparation process of the mixture material for preparing lithium titanate at 600 to 900° C. to obtain lithium titanate.

The preparation process of mixture material for preparing lithium titanate related to the preparation method (1) of the lithium titanate material is carried out by mixing a lithium compound serving as reactive material of lithium titanate, with titanium dioxide to prepare a mixture material for preparing lithium titanate.

The lithium compound related to the preparation process of mixture material for preparing lithium titanate is not particularly limited and examples thereof include inorganic lithium compounds such as lithium hydroxide, lithium carbonate and lithium nitrate. Of these, lithium carbonate and lithium hydroxide are preferred as the lithium compound, in that they are industrially available and cheap.

The mean particle diameter of the lithium compound related to the preparation process of mixture material for preparing lithium titanate is preferably 1.0 to 20.0 μm, particularly preferably 1.0 to 10.0 μm, when obtained by a laser light scattering method. When the mean particle diameter of the lithium compound is within the range defined above, miscibility of the lithium compound with titanium dioxide is improved.

The titanium dioxide related to the preparation process of mixture material for preparing lithium titanate is titanium dioxide prepared by a sulfuric acid method. The preparation method of titanium dioxide using a sulfuric acid method is carried out by dissolving ilmenite rock (FeTiO₃) as a material in sulfuric acid, treating a titanium powder with a water-soluble salt, performing hydrolysis, precipitating the resulting hydrolysates with metatitanate, a precursor of titanium dioxide, and baking the metatitanate to obtain titanium dioxide.

The titanium dioxide related to the preparation process of mixture material for preparing lithium titanate preferably contains an anatase-type content of 90% or more in that reactivity is improved.

The mean particle diameter (obtained by a laser light scattering method) of the titanium dioxide related to the preparation process of mixture material for preparing lithium titanate is preferably 3.0 μm or less, particularly preferably 0.1 to 3.0 μm.

The specific surface area (based on a BET method) of the titanium dioxide related to the preparation process of mixture material for preparing lithium titanate is 1.0 to 50.0 m²/g, preferably 20.0 to 40.0 m²/g.

The method for mixing the lithium compound with titanium dioxide, related to the preparation process of mixture material for preparing lithium titanate may be a wet mixing method in which two ingredients are mixed in a solvent, or a dry mixing method in which the two ingredients are mixed without using any solvent, so long as it enables preparation of a homogeneous mixture.

The mixing ratio of the lithium compound with titanium dioxide, related to the preparation process of mixture material for preparing lithium titanate is preferably 0.70 to 0.90, particularly preferably 0.75 to 0.85, as a molar ratio (Li/Ti) of lithium atoms in lithium compound and titanium atoms in titanium dioxide.

In addition, after the preparation process of mixture material for preparing lithium titanate is performed, the mixture material for preparing lithium titanate may be used in the subsequent baking process, without any treatment, or the mixture material for preparing lithium titanate may be used in the subsequent baking process, after molding under pressure.

The baking process related to the preparation method (1) of lithium titanate material is carried out by preparing a mixture material for preparing lithium titanate and baking the resulting mixture of lithium compound and titanium dioxide, to obtain lithium titanate.

In the baking process, the temperature at which lithium compound and titanium dioxide are baked is 700 to 1,000° C., preferably 700 to 900° C. In addition, the baking time is preferably one hour or more, particularly preferably 1 to 10 hours, and a baking atmosphere is not particularly limited and may be any one of an air atmosphere, an oxygen atmosphere and an inert atmosphere.

In the baking process, baking may be performed two or more times, if necessary. That is, the material which undergoes baking once may be baked again. In addition, in the baking process, the material which undergoes baking once is ground, powder properties are homogenized and the resulting material may be then baked again. In addition, after the baking process, the resulting material may be suitably cooled, ground and screened, if necessary.

In addition, in the preparation method (1) of lithium titanate material, lithium titanate represented by general formula (1) is obtained by the baking process.

In addition, the preparation method of lithium titanate material may use metatitanate or orthotitanate as another raw material, as raw materials of titanium oxide.

In the preparation method of the anode active material for lithium secondary batteries of the present invention, the magnesium compound material is preferably magnesium oxide, magnesium phosphate or magnesium sulfate in that rapid charging and discharging properties of lithium secondary batteries are improved.

The anode active material for lithium secondary batteries of the present invention exhibits superior performances as an anode active material for lithium secondary batteries, thus being useful as an anode active material for lithium secondary batteries.

The lithium secondary battery of the present invention uses the anode active material for lithium secondary batteries of the present invention as an anode active material of lithium secondary batteries and includes a cathode, an anode, a separator, and a non-aqueous electrolyte containing a lithium salt. In addition, the lithium secondary battery of the present invention exhibits superior battery performances, particularly cycle properties and may have any shape of a button, sheet, cylinder, square, coin and the like. In addition, use of the lithium secondary battery is not particularly limited and the lithium secondary battery is suitable for use in hybrid electric vehicle (HEVs) and stationary large batteries, for example, in electrical equipment such as notebook PCs, lap-top PCs, pocket word processors, cellular phones, cordless handsets, portable CD players, radios, liquid crystal TVs, backup powers, electric shavers, memory cards and video movies, and such as game machines for consumer applications.

### EXAMPLE

Hereinafter, the present invention will be described in detail with reference to the following Examples and is not limited thereto.

### Example 1

### Preparation of Lithium Titanate Material

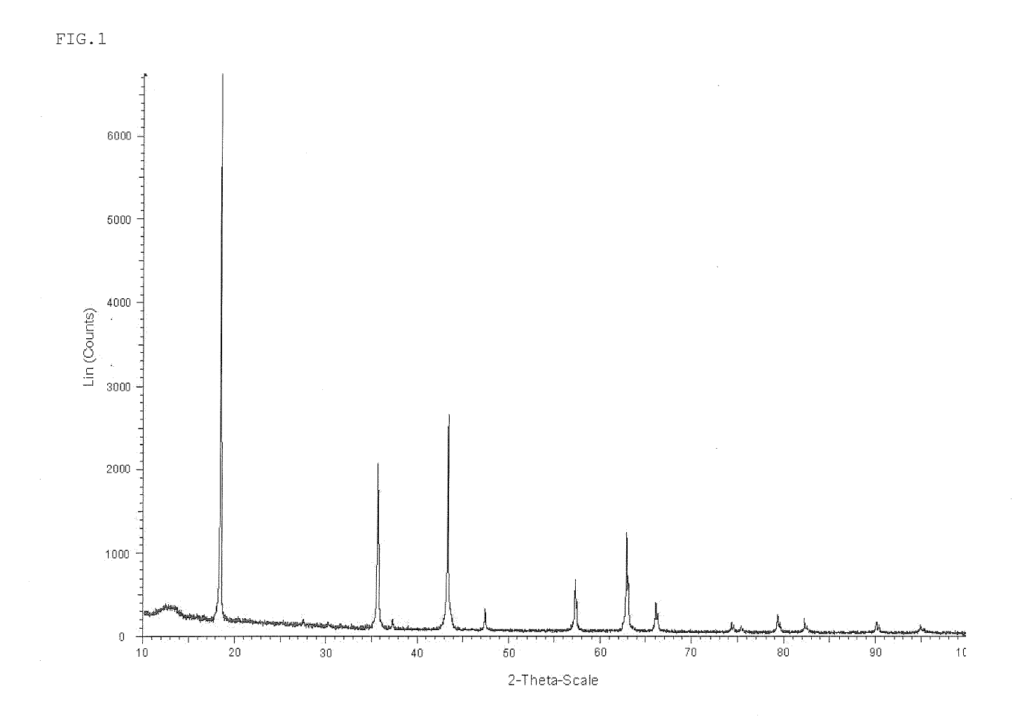

Titanium dioxide (mean particle diameter of 5.2 μm, BET specific surface area of 29.8 m²/g, rutilization ratio of 5.0% or less) obtained by a sulfuric acid method and lithium carbonate (Li₂CO₃, mean particle diameter of 8.2 μm) were mixed such that a molar ratio (Li/Ti) of lithium atoms in lithium carbonate to titanium atoms was 0.800, followed by wet-mixing. Then, the resulting mixture was baked in the air at 850° C. for 5 hours, cooled and disintegrated to obtain lithium titanate. The resulting lithium titanate was Li₄Ti₅O₁₂ and the Li/Ti molar ratio was 0.800. The XRD analysis results of lithium titanate thus obtained are shown in FIG. 1.

In addition, the lithium titanate was present in the form of monodispersed particles. 100 of the particles were randomized and observed by SEM to obtain a mean particle diameter as 0.52 μm.

<Preparation of Anode Active Material for Lithium Secondary Battery>

Then, the lithium titanate thus obtained was dispersed in pure water such that a solid concentration was 40%. Then, 1.20% by weight of magnesium oxide (mean particle diameter of 0.5 μm), based on the weight of Mg in terms of atoms with respect to the weight of lithium titanate was added. Then, the mixture was wet mixed using a wet bead mill, until the mean particle diameter of solid in a slurry reached 0.5 μm to obtain an aqueous slurry. Then, the aqueous slurry was sprayed using a spray dryer whose inlet temperature was set at 200° C., to obtain an anode active material for lithium secondary batteries. In addition, the mean particle diameter of solid in the slurry was measured with a particle size distribution meter (under the trade name of MICROTRAC, Model No. MT3000II, manufactured by NIKKISO CO., LTD.) using a laser method.

<Analysis of Anode Active Material for Lithium Secondary Batteries>

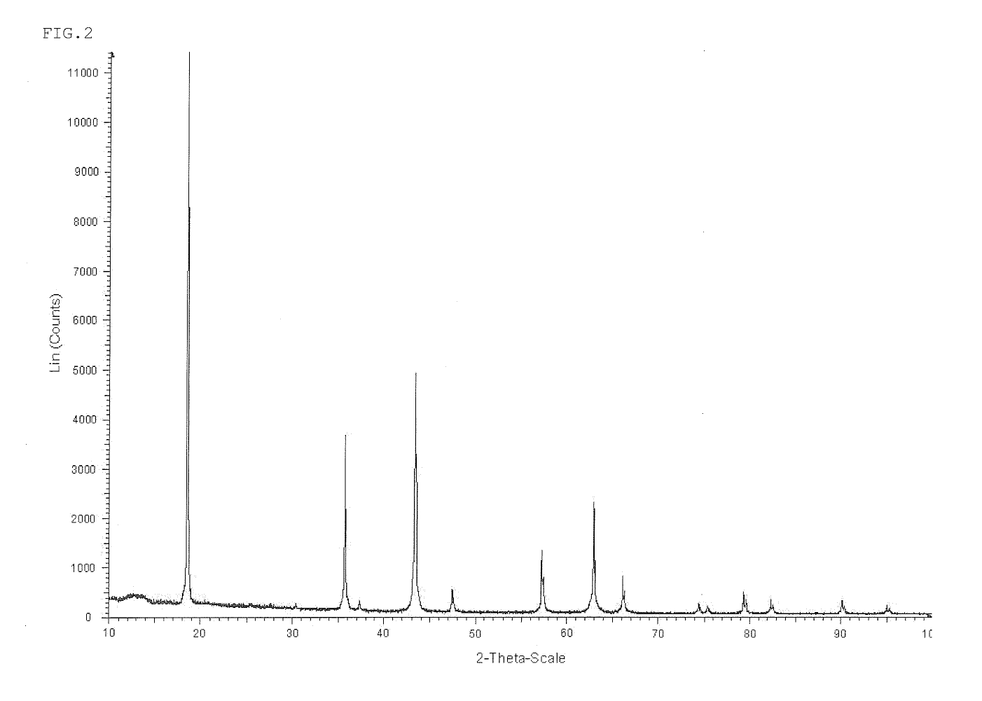

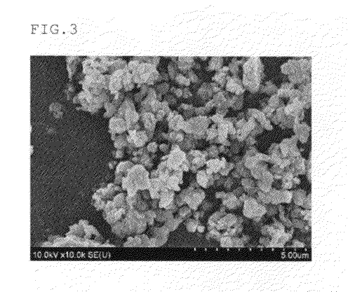

Then, the anode active material for lithium secondary batteries thus obtained was subjected to SEM analysis. As a result, it could be confirmed that the anode active material was composed of secondary particles in which primary particles of lithium titanate were aggregated (FIG. 3). In addition, as a result of XRD analysis, diffraction peaks derived from lithium titanate were observed (FIG. 2). Rietveld analysis was performed in the diffraction chart and a lattice constant was calculated. As a result, it could be seen that variation in values derived from a magnesium-doped substance was not observed and the anode active material for lithium secondary batteries was composed of aggregations (secondary particles) in which primary particles of lithium titanate were aggregated with magnesium oxide. The mean particle diameter (secondary particles) of anode active material thus obtained was measured with a particle size distribution meter using a laser method. In addition, a BET specific surface area of the anode active material was measured.

### Example 2

### Preparation of Lithium Titanate Material

Lithium titanate was obtained in the same manner as in Example 1.

<Preparation of Anode Active Material for Lithium Secondary Batteries>

Then, the lithium titanate thus obtained was dispersed in pure water such that the solid concentration was 40%. Then, 2.85% by weight of magnesium sulfate based on the weight of Mg atom conversion with respect to the weight of lithium titanate was added and was dissolved in a slurry. Then, the mixture was wet mixed using a wet bead mill, until the mean particle diameter of solid in a slurry reached 0.8 μm to obtain an aqueous slurry. Then, the aqueous slurry was sprayed using a spray dryer whose inlet temperature was set at 250° C., to obtain an anode active material for lithium secondary batteries. The mean particle diameter of solid in the slurry was measured with a particle size distribution meter using a laser method.

<Analysis of Anode Active Material for Lithium Secondary Batteries>

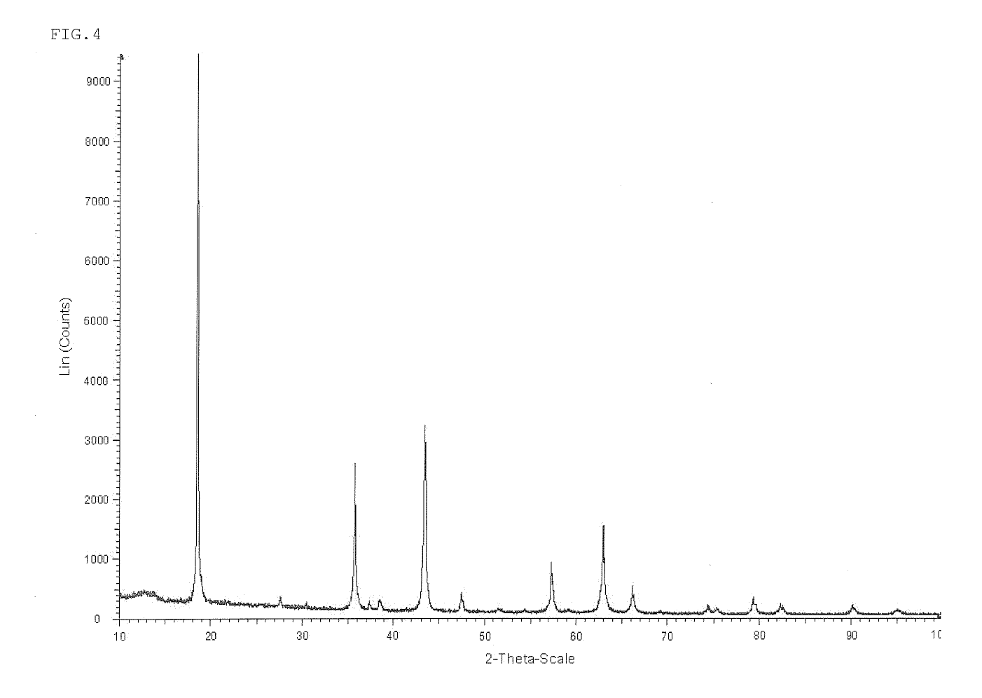

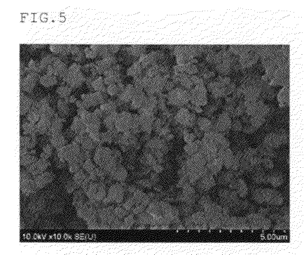

Then, the anode active material for lithium secondary batteries thus obtained was subjected to SEM analysis. As a result, it could be confirmed that the anode active material was composed of secondary particles in which primary particles of lithium titanate were aggregated (FIG. 5). In addition, as a result of XRD analysis, diffraction peaks derived from lithium titanate were observed (FIG. 4). Rietveld analysis was performed in the diffraction chart and a lattice constant was calculated. As a result, it could be seen that variation in values derived from a magnesium-doped substance was not observed and the anode active material for lithium secondary batteries was composed of aggregations (secondary particles) in which a plurality of primary particles of lithium titanate whose surfaces were covered with sulfate magnesium was aggregated.

The mean particle diameter (secondary particles) of anode active material thus obtained was measured with a particle size distribution meter using a laser method. In addition, a BET specific surface area of the anode active material was measured.

### Example 3

### Preparation of Lithium Titanate Material

Lithium titanate was obtained in the same manner as in Example 1.

<Preparation of Anode Active Material for Lithium Secondary Batteries>

Then, the lithium titanate thus obtained was dispersed in pure water such that the solid concentration was 40%. Then, 4.80% by weight of magnesium oxide (mean particle diameter of 0.5 μm), based on Mg in terms of atom with respect to lithium titanate was added. Then, the mixture was wet-mixed using a wet bead mill, until the mean particle diameter of solid in a slurry reached 0.3 μm to obtain an aqueous slurry. Then, the aqueous slurry was sprayed using a spray dryer whose inlet temperature was set at 160° C., to obtain an anode active material for lithium secondary batteries.

<Analysis of Anode Active Material for Lithium Secondary Battery>

Then, the anode active material for lithium secondary batteries thus obtained was subjected to SEM analysis. As a result, it could be confirmed that the anode active material was composed of secondary particles in which primary particles of lithium titanate were aggregated. In addition, as a result of XRD analysis, diffraction peaks derived from lithium titanate were observed. Rietveld analysis was performed in the diffraction chart and a lattice constant was calculated. As a result, it could be seen that variation in values derived from a magnesium-doped substance was not observed and the anode active material for lithium secondary batteries was composed of aggregations (secondary particles) in which primary particles of lithium titanate whose surfaces were covered with magnesium oxide were aggregated.

The mean particle diameter (secondary particles) of anode active material thus obtained was measured with a particle size distribution meter using a laser method. In addition, a BET specific surface area of the anode active material was measured.

### Example 4

### Preparation of Lithium Titanate Material

Lithium titanate was obtained in the same manner as in Example 1.

<Preparation of Anode Active Material for Lithium Secondary Batteries>

Then, the lithium titanate thus obtained was dispersed in pure water such that the solid concentration was 40%. Then, 0.50% by weight of magnesium sulfate (based on Mg in terms of atoms with respect to lithium titanate) was added and dissolved in a slurry. Then, the mixture was wet mixed using a wet bead mill until the mean particle diameter of solid in a slurry reached 0.5 μm to obtain an aqueous slurry. Then, the aqueous slurry was sprayed using a spray dryer whose inlet temperature was set at 180° C., to obtain an anode active material for lithium secondary batteries.

The mean particle diameter of solid in the slurry was measured with a particle size distribution meter using a laser method.

<Analysis of Anode Active Material for Lithium Secondary Batteries>

Then, the anode active material for lithium secondary batteries thus obtained was subjected to SEM analysis. As a result, it could be confirmed that the anode active material was composed of secondary particles in which primary particles of lithium titanate were aggregated. In addition, as a result of XRD analysis, diffraction peaks derived from lithium titanate were observed. Rietveld analysis was performed in the diffraction chart and a lattice constant was calculated. As a result, it could be seen that variation in values derived from a magnesium-doped substance was not observed and the anode active material for lithium secondary batteries was composed of aggregations (secondary particles) in which a plurality of primary particles of lithium titanate whose surfaces were covered with sulfate magnesium was aggregated.

The mean particle diameter (secondary particles) of anode active material thus obtained was measured with a particle size distribution meter using a laser method. In addition, a BET specific surface area of the anode active material was measured.

### Example 5

Lithium titanate was obtained in the same manner as in Example 1.

<Preparation of Anode Active Material for Lithium Secondary Batteries>

Then, the lithium titanate thus obtained was dispersed in pure water such that the solid concentration was 40%. Then, 0.90% by weight of magnesium phosphate (mean particle diameter of 0.3 μm), based on the weight of Mg in terms of atom with respect to the weight of lithium titanate was added. Then, the mixture was wet mixed using a wet bead mill, until the mean particle diameter of solid in a slurry reached 0.8 μm to obtain an aqueous slurry. Then, the aqueous slurry was sprayed using a spray dryer whose inlet temperature was set at 190° C., to obtain an anode active material for lithium secondary batteries.

The mean particle diameter of solid in the slurry was measured with a particle size distribution meter using a laser method.

<Analysis of Anode Active Material for Lithium Secondary Battery>

Then, the anode active material for lithium secondary batteries thus obtained was subjected to SEM analysis. As a result, it could be confirmed that the anode active material was composed of secondary particles in which primary particles of lithium titanate were aggregated. In addition, as a result of XRD analysis, diffraction peaks derived from lithium titanate were observed. Rietveld analysis was performed in the diffraction chart and a lattice constant was calculated. As a result, it could be seen that variation in values derived from a magnesium-doped substance was not observed and the anode active material for lithium secondary batteries was composed of aggregations (secondary particles) in which primary particles of lithium titanate were aggregated with magnesium phosphate. The mean particle diameter (secondary particles) of anode active material thus obtained was measured with a particle size distribution meter using a laser method. In addition, a BET specific surface area of the anode active material was measured.

### Comparative Example 1

### Preparation of Lithium Titanate Material

Lithium titanate was obtained in the same manner as in Example 1.

<Preparation of Anode Active Material for Lithium Secondary Batteries>

Then, the lithium titanate thus obtained was dispersed in pure water such that the solid concentration was 40%. Then, the dispersion was wet mixed using a wet bead mill until the mean particle diameter of solid in a slurry reached 0.5 μm to obtain an aqueous slurry. Then, the aqueous slurry was sprayed using a spray dryer whose inlet temperature was set at 200° C., to obtain an anode active material for lithium secondary batteries.

The mean particle diameter of solid in the slurry was measured with a particle size distribution meter using a laser method.

<Analysis of Anode Active Material for Lithium Secondary Battery>

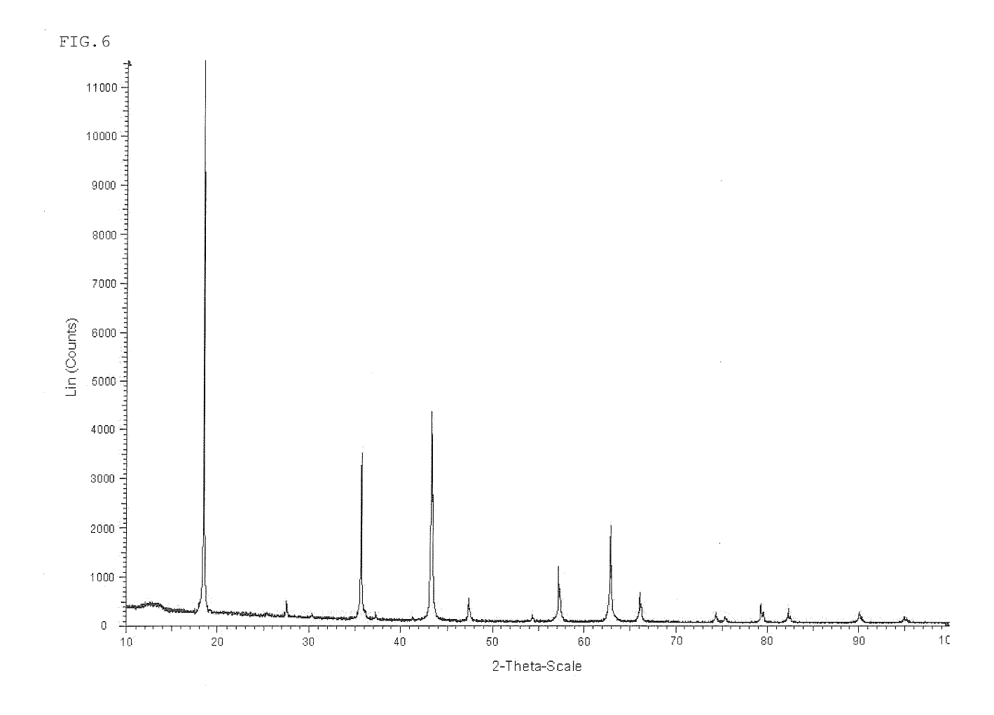

Then, the anode active material for lithium secondary batteries was subjected to XRD analysis. The results thus obtained are shown in FIG. 6. In the diffraction chart, peaks derived from lithium titanate were observed. It could be confirmed that the anode active material was composed of aggregations (secondary particles) in which primary particles of lithium titanate were aggregated.

The mean particle diameter (secondary particles) of anode active material thus obtained was measured with a particle size distribution meter using a laser method. In addition, a BET specific surface area of the anode active material was measured.

### Comparative Example 2

### Preparation of Mg-Doped Lithium Titanate

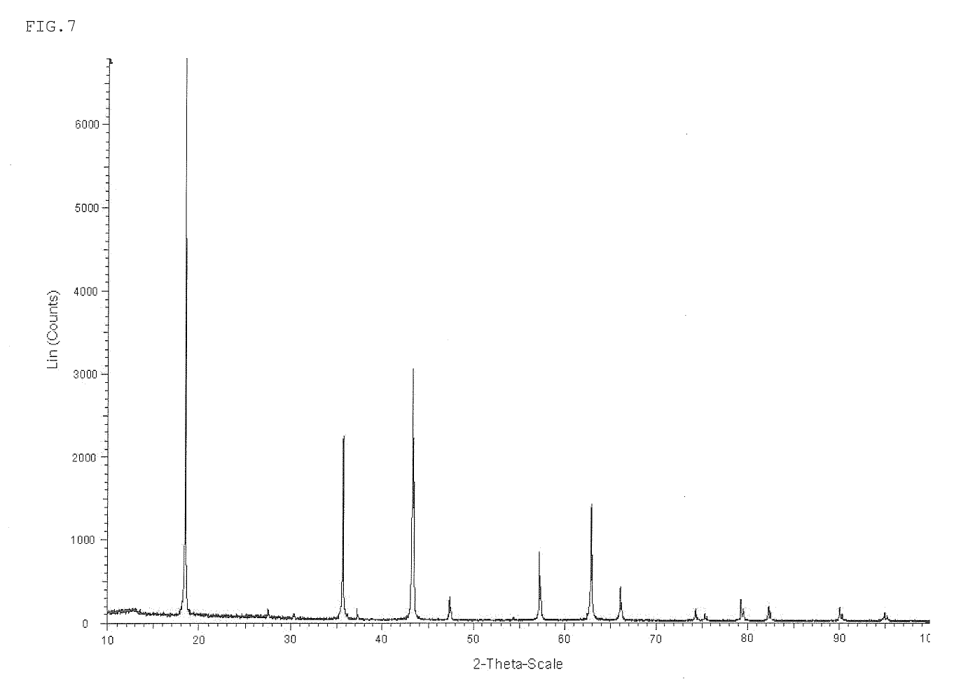

Titanium dioxide (mean particle diameter of 5.2 μm, BET specific surface area of 29.8 m²/g, rutilization ratio of 5.0% or less) obtained by a sulfuric acid method, lithium carbonate (Li₂CO₃, mean particle diameter of 8.2 μm) and magnesium oxide were mixed such that the Mg atoms in magnesium oxide were 1.20% by weight with respect to the formed lithium titanium atoms, followed by dry-mixing. Then, the resulting mixture was baked in the air at 850° C. for 5 hours, cooled and disintegrated to obtain lithium titanate. As a result of XRD analysis, it could be confirmed that lithium titanate thus obtained was Mg-doped lithium titanate. The XRD analysis results of lithium titanate are shown in FIG. 7.

In addition, the Mg-doped lithium titanate obtained was present in the form of monodispersed particles. 100 of the particles were randomized and observed by SEM to obtain a mean particle diameter as 0.8 μm.

<Preparation of Anode Active Material for Lithium Secondary Batteries>

Then, the Mg-doped lithium titanate thus obtained was dispersed in pure water such that the solid concentration was 40%. Then, the dispersion was wet mixed using a wet bead mill until the mean particle diameter of solid in a slurry reached 0.5 μm to obtain an aqueous slurry. Then, the aqueous slurry was sprayed using a spray dryer whose inlet temperature was set at 200° C., to obtain an anode active material for lithium secondary batteries.

The mean particle diameter of solid in the slurry was measured with a particle size distribution meter using a laser method.

<Analysis of Anode Active Material for Lithium Secondary Battery>

Then, the anode active material for lithium secondary batteries was subjected to SEM analysis. The results thus obtained showed that primary particles of lithium titanate were aggregated to form aggregations (secondary particles). Rietveld analysis was performed in the diffraction chart. Variation in lattice constant of Mg-doped lithium titanate was observed. Accordingly, it could be seen that the anode active material was composed of aggregations (secondary particles) in which primary particles of Mg-doped lithium titanate were aggregated. The mean particle diameter (secondary particles) of anode active material thus obtained was measured with a particle size distribution meter using a laser method. In addition, a BET specific surface area of the anode active material was measured.

TABLE 1

| | | Magnesium compound | | | |
|---|---|---|---|---|---|
| | | | Weight | | |
| | | | based | Mean | Spray- |
| | | | on Mg | particle | ing |
| | | | in terms | diameter | heating |
| | | | of atoms | of solid in | temper- |
| | Lithium | | (% by | slurry | ature |
| | titanate | Type | weight)¹⁾ | (μm) | (° C.) |
| Ex. 1 | Li₄Ti₅O₁₂ | MgO | 1.20 | 0.5 | 200 |
| Ex. 2 | Li₄Ti₅O₁₂ | MgSO₄•7H₂O | 2.85 | 0.3 | 250 |
| Ex. 3 | Li₄Ti₅O₁₂ | MgO | 4.80 | 0.4 | 160 |
| Ex. 4 | Li₄Ti₅O₁₂ | MgSO₄•7H₂O | 0.50 | 0.5 | 180 |
| Ex. 5 | Li₄Ti₅O₁₂ | Mg₃(PO₄)₂•8H₂O | 0.90 | 0.5 | 190 |
| Comp. | Li₄Ti₅O₁₂ | — | — | 0.5 | 200 |
| Ex. 1 | | | | | |

| | | | | |
|---|---|---|---|---|
| Comp. | Mg-doped lithium | 1.20 | 0.5 | 200 |
| Ex. 2 | titanate²⁾ | | | |

¹⁾a weight ratio (% by weight) of weight of Mg atoms in magnesium compound to weight of lithium titanate exhibited.
²⁾Mg-doped lithium titanate

TABLE 2

| | Physical properties of | | | |
|---|---|---|---|---|
| | anode active material samples | | | |
| | | BET | | |
| | Diameter of | specific | a-axis | |
| | secondary | surface | lattice | |
| | particles | area | constant | Characteristics of |
| | (μm) | (m²/g) | (Å) | particles |
| Ex. 1 | 0.52 | 4.7 | 8.360 | Primary particles of |
| | | | | lithium titanate and |
| | | | | magnesium oxide are |
| | | | | aggregated to form |
| | | | | aggregations |
| | | | | (secondary particles) |
| Ex. 2 | 0.81 | 10.4 | 8.360 | Primary particles of |
| | | | | lithium titanate whose |
| | | | | surfaces are covered with |
| | | | | magnesium sulfate are |
| | | | | aggregated to form |
| | | | | aggregations (secondary |
| | | | | particles) |
| Ex. 3 | 1.5 | 3.5 | 8.360 | Primary particles of |
| | | | | lithium titanate and |
| | | | | magnesium oxide are |
| | | | | aggregated to form |
| | | | | aggregations |
| | | | | (secondary particles) |
| Ex. 4 | 3.2 | 8.1 | 8.360 | Primary particles of |
| | | | | lithium titanate whose |
| | | | | surfaces are covered with |
| | | | | magnesium sulfate are |
| | | | | aggregated to form |
| | | | | aggregations (secondary |
| | | | | particles) |
| Ex. 5 | 1.1 | 10.2 | 8.360 | Primary particles of |
| | | | | lithium titanate and |
| | | | | magnesium oxide are |
| | | | | aggregated to form |
| | | | | aggregations |
| | | | | (secondary particles) |
| Comp. | 1.5 | 5.2 | 8.360 | Primary particles of |
| Ex. 1 | | | | lithium titanate are |
| | | | | aggregated to form |
| | | | | aggregations |
| | | | | (secondary particles) |
| Comp. | 1.2 | 8.1 | 8.363 | Primary particles of |
| Ex. 2 | | | | Mg-doped lithium titanate |
| | | | | are aggregated to form |
| | | | | aggregations |
| | | | | (secondary particles) |

<Performance Test of Anode Active Material for Lithium Secondary Batteries>

<Battery Performance Test>

(1) Fabrication of Lithium Secondary Battery

70 parts by weight of the anode active material sample of Examples 1 to 5 and Comparative Examples 1 to 2 thus prepared as anode active materials, 15 parts by weight of acetylene black as a conducting agent, 15 parts by weight of polyvinylidenefluoride (PVDF) as a binder and n-methyl-2-pyrrolidone as a solvent were mixed together to prepare an electrode mix.

The electrode mix was applied by a doctor blade method such that the thickness of dried aluminum foil was 0.01 g/cm².

Then, the electrode mix was dried under vacuum at 150° C. for 24 hours and roll-pressed to 80% of the thickness of film immediately after application and a hole with an area of 1 cm² was punched to obtain an anode for coin batteries. The anode and members such as a separator, an anode, a cathode, a collector plate, built-in apparatuses, an outer terminal and an electrolyte were used to fabricate a lithium secondary battery.

A metal lithium plate was used as the cathode. A copper plate was used as the collector plate. A polypropylene porous film was used as the separator. A solution of LiPF₆ (1 mol/L) in a mixture of equivalent amounts of ethylene carbonate and ethyl methyl carbonate was used as the electrolyte.

(2) Charge and Discharge Test

A cycle in which the coin batteries thus fabricated was charged at a constant current with a current density of 0.2 C to 1.0 V at 25° C. and then discharged to 2.0 V was repeated 20 times.

Then, a cycle in which coin batteries were charged at a constant current with a current density of 10.0 C to 1.0 V and discharged to 20 V at 25° C. was repeated 3 times.

The maximum charge capacities at current densities of 0.2 C and 10.0 C were considered to be charge capacities of the respective current densities. The results thus obtained are shown in Table 3.

In addition, in this charge and discharge test, an intercalation reaction of lithium into the anode active material and a deintercalation reaction of lithium therefrom were defined as a “charge” and a “discharge”, respectively.

(3) High-Temperature Storage Test

After the charge and discharge test, the coin batteries were stored in a bath at a constant temperature of 60° C., cooled to 25° C. again, a cycle including charge at a constant current with a current density of 10.0 C to 1.0 V and discharge to 2.0 V at 25° C. were repeated 3 times to perform the battery test. The results thus obtained are shown in Table 3.

TABLE 3

| | Battery test | | |
|---|---|---|---|
| | | | 25° C., 10 C charge |
| | | | capacity after |
| | | | standing |
| | 25° C., 0.2 C charge | 25° C., 10 C charge | overnight at 60° C. |
| | capacity (mAh/g) | capacity (mAh/g) | (mAh/g) |
| Ex. 1 | 168 | 111 | 110 |
| Ex. 2 | 165 | 113 | 111 |
| Ex. 3 | 164 | 106 | 103 |
| Ex. 4 | 166 | 111 | 110 |
| Ex. 5 | 165 | 110 | 110 |
| Comp. | 165 | 105 | 66 |
| Ex. 1 | | | |
| Comp. | 164 | 105 | 72 |
| Ex. 2 | | | |

The present invention enables preparation of a lithium secondary battery which exhibits a superior high temperature maintenance property and excellent rapid charging and discharging properties.

1. An anode active material for lithium secondary batteries comprising:
lithium titanate represented by the following general formula (1); and
a magnesium compound
LiₓTi_{y}O₁₂ (1)
(wherein x and y satisfy 3.0≦x≦5.0, 4.0≦y≦6.0 and 0.70≦x/y≦0.90).

2. The anode active material according to claim 1, wherein a primary particle of lithium titanate represented by general formula (1) is aggregated together with a magnesium compound to form aggregations (secondary particles).

3. The anode active material according to claim 1, wherein a plurality of primary particles of lithium titanate represented by general formula (1), in which the surfaces of primary particles are covered with a magnesium compound, is aggregated to form aggregations (secondary particles).

4. The anode active material according to claim 1, wherein a weight ratio of magnesium atoms to lithium titanate represented by general formula (1) is 0.1 to 5.0% by weight.

5. The anode active material according to claim 1, wherein the magnesium compound is magnesium oxide, magnesium phosphate or magnesium sulfate.

6. The anode active material according to claim 1, wherein the mean particle diameter of primary particles of the lithium titanate represented by general formula (1) is 2 μm or less.

7. A method for preparing an anode active material for lithium secondary batteries, comprising incorporating a magnesium compound in lithium titanate represented by the following general formula (1):
LiₓTi_{y}O₁₂ (1)
(wherein x and y satisfy 3.0≦x≦5.0, 4.0≦y≦6.0 and 0.70≦x/y≦0.90).

8. A method for preparing an anode active material for lithium secondary batteries comprising:
mixing a lithium titanate material with a magnesium compound material in an aqueous solvent to obtain an aqueous slurry (A) (wet mixing process (A)); and
heating the aqueous slurry (A) to 50 to 500° C. to obtain an anode active material for lithium secondary batteries (heating process (A))
wherein the lithium titanate material is lithium titanate represented by the following general formula (1):
LiₓTi_{y}O₁₂ (1)
(wherein x and y satisfy 3.0≦x≦5.0, 4.0≦y≦6.0 and 0.70≦x/y≦0.90).

9. The method according to claim 8, wherein the wet mixing process (A) is carried out by mixing a lithium titanate material with a magnesium compound material in an aqueous solvent, while wet-grinding a solid in the slurry using a granular medium.

10. The method according to claim 8, wherein the magnesium compound material is a water-soluble magnesium compound.

11. The method according to claim 8, wherein the heating process (A) is carried out by spraying the aqueous slurry (A) in a spray dryer.

12. The method according to claim 8, wherein the lithium titanate material is obtained by mixing materials for preparing lithium titanate to prepare a mixture of a lithium compound and titanium dioxide which is obtained by a sulfuric acid method and has a specific surface area (based on a BET method) of 1.0 to 50.0 m²/g, and baking the mixture of lithium compound and titanium dioxide obtained by the mixing materials for preparing lithium titanate at 600 to 900° C. to obtain lithium titanate.

13. The method according to claim 8, wherein the magnesium compound material is magnesium oxide, magnesium phosphate or magnesium sulfate.

14. A lithium secondary battery using the anode active material for lithium secondary batteries according to claim 1, as an anode active material.

15. The anode active material according to claim 2, wherein a weight ratio of magnesium atoms to lithium titanate represented by general formula (1) is 0.1 to 5.0% by weight.

16. The anode active material according to claim 2, wherein the magnesium compound is magnesium oxide, magnesium phosphate or magnesium sulfate.

17. The anode active material according to claim 2, wherein the mean particle diameter of primary particles of the lithium titanate represented by general formula (1) is 2 μm or less.

18. The method according to claim 9, wherein the magnesium compound material is a water-soluble magnesium compound.

19. The method according to claim 9, wherein the heating process (A) is carried out by spraying the aqueous slurry (A) in a spray dryer.

20. The method according to claim 9, wherein the lithium titanate material is obtained by mixing materials for preparing lithium titanate to prepare a mixture of a lithium compound and titanium dioxide which is obtained by a sulfuric acid method and has a specific surface area (based on a BET method) of 1.0 to 50.0 m²/g, and baking the mixture of lithium compound and titanium dioxide obtained by the mixing materials for preparing lithium titanate at 600 to 900° C. to obtain lithium titanate.
